(19) United States
(12) Patent Application Publication
(10) Pub. No.: US 2018/0164487 A1
(43) Pub. Date: Jun. 14, 2018

(54) LIGHT GUIDE PLATE, MOLD AND MANUFACTURING METHOD THEREOF, BACKLIGHT MODULE AND DISPLAY DEVICE

(71) Applicant: BOE TECHNOLOGY GROUP CO., LTD., Beijing (CN)

(72) Inventors: Hongfei CHENG, Beijing (CN); Yuxin ZHANG, Beijing (CN)

(21) Appl. No.: 15/554,486

(22) PCT Filed: Feb. 17, 2017
(86) PCT No.: PCT/CN2017/073901

§ 371 Date: Aug. 30, 2017

(30) Foreign Application Priority Data
May 23, 2016 (CN) 201610345963.4

(51) Int. Cl. F21V 8/00; G09F 13/18

(52) U.S. Cl. CPC G02B 6/0025; G09F 2013/1854; G09F 13/18; G02B 6/0065

(57) ABSTRACT

Provided in the embodiments of the present disclosure are a light guide plate and a mold and a manufacturing method thereof, a backlight module and a display device. The light guide plate guides the light emitted from a light source. The light guide plate includes a light incident surface which attaches to a light emergent surface of the light source. The light guide plate may be integrated with the light source. The light guide plate mold is used for manufacturing the light guide plate described above. The light guide plate mold includes a bottom plate and a side plate. The side plate includes a circuit board with a light source on, the side of the light incident surface.

### CROSS REFERENCE TO RELATED APPLICATIONS

This patent application is a National Stage Entry of PCT/CN2017/073901 filed on Feb. 17, 2017, which claims the benefit and priority of Chinese Patent Application No. 201610345963.4 filed on May 23, 2016, the disclosures of which are incorporated herein by reference in their entirety as part of the present application.

### BACKGROUND

The present disclosure relates to the field of display technology, and particularly, to a light guide plate, and a mold and a manufacturing method thereof, a backlight module, and a display device.

An existing display often needs a light emitting device. For example, a liquid crystal display needs a backlight module behind a liquid crystal display panel. The backlight module generally includes a light source, a light guide plate, an optical film, and the like. It is easy for a gap existing between the light guide plate and the light source. Not all of the light emitted from the light source may be guided by the light guide plate to irradiate the liquid crystal display panel. A loss of light occurs, an energy consumption increases, and a display quality declines.

### BRIEF DESCRIPTION

Embodiments of the present disclosure provide a light guide plate, a mold and a manufacturing method thereof, a backlight module, and a display device.

A first aspect of embodiments of the present disclosure provides a light guide plate configured to guide a light emitted from a light source. A light incident surface of the light guide plate attaches to the light emergent surface of the light source.

In embodiments of the present disclosure, the light guide plate is integrated with the light source.

In embodiments of the present disclosure, the light guide plate further includes a dot distribution surface which intersects the light incident surface. A plurality of dots are arranged on the dot distribution surface.

In embodiments of the present disclosure, on the dot distribution surface, the number of the dots increases along a direction away from the light incident surface.

In embodiments of the present disclosure, on the dot distribution surface, a size of the dot increases along a direction away from the light incident surface.

In embodiments of the present disclosure, the light guide plate includes silicon rubber.

A second aspect of embodiments of the present disclosure provides a light guide plate mold for manufacturing the light guide plate. The light guide plate mold includes a bottom plate and a side plate. The side plate includes a circuit board with the light source.

In embodiments of the present disclosure, the light guide plate is integrated with the circuit board.

In embodiments of the present disclosure, the bottom plate includes a plurality of recesses configured to form a plurality of dots of the light guide plate.

In embodiments of the present disclosure, on the bottom plate, the number of the recesses increases along a direction away from the circuit board.

In embodiments of the present disclosure, on the bottom plate, a size of the recess increases along a direction away from the circuit board.

In embodiments of the present disclosure, the light guide plate mold further includes a cover plate with a hole.

A third aspect of embodiments of the present disclosure provides a light guide plate manufacturing method for manufacturing the above-described light guide plate. The method includes preparing a light guide plate mold, adding a material for preparing the light guide plate into the mold, curing the material, and stripping the mold to obtain a light guide plate. The light guide plate mold includes a bottom plate and a side plate, and the side plate includes a circuit board with the light source, on the side of the light incident surface.

In embodiments of the present disclosure, stripping the mold to obtain a light guide plate includes retaining the circuit board such that the circuit board and the light guide plate are integrally molded.

In embodiments of the present disclosure, the bottom plate of the light guide plate mold includes a plurality of recesses.

In embodiments of the present disclosure, the light guide plate manufacturing method further includes printing dots on the light guide plate, after stripping the mold to obtain the light guide plate.

In embodiments of the present disclosure, the light guide plate manufacturing method further includes keeping the material standing to remove the air, before adding the material for preparing the light guide plate into the mold.

In the presently disclosed embodiment, the material is kept standing for 5 minutes.

In embodiments of the present disclosure, the light guide plate manufacturing method further includes performing vacuum defoaming on the material.

In embodiments of the present disclosure, the material for preparing the light guide plates includes organic silicon pouring sealant.

In embodiments of the present disclosure, the organic silicon pouring sealant includes room-temperature silicon sulfide rubber or high-temperature silicon sulfide rubber.

In embodiments of the present disclosure, the curing the material includes room-temperature curing or heat curing.

In embodiments of the present disclosure, the light guide plate manufacturing method further includes finishing the light guide plate, after stripping the mold to obtain the light guide plate.

A fourth aspect of embodiments of the present disclosure provides a backlight module including the light guide plate described above.

A fifth aspect of embodiments of the present disclosure provides a display device including the backlight module described above.

According to the light guide plate and the mold and the manufacturing method thereof, the backlight module and the display device in the embodiments of the present disclosure, the light incident surface of the light guide plate closely abuts and fits the light emergent surface of the light source. The gap between the light guide plate and the light source is reduced or avoided. Thus, the loss of light is reduced, the energy consumption is reduced, and the display quality is improved.

### BRIEF DESCRIPTION OF THE DRAWINGS

In order to more clearly illustrate the technical solutions of the embodiments of the present disclosure, the drawings of the embodiments will be briefly described below. It should be recognized that the drawings described below only relate to some embodiments of the present disclosure, rather than limiting the present disclosure, wherein:

FIG. 1 is a schematic view of the structure of a light guide plate provided in a first embodiment of the present disclosure;

FIG. 2 is a schematic view of a first structure of a light guide plate mold provided in a second embodiment of the present disclosure;

FIG. 3 is a schematic view of a second structure of the light guide plate mold provided in the second embodiment of the present disclosure;

FIG. 4 is a schematic view of the structure of a circuit board in the light guide plate mold provided in embodiments of the present disclosure;

FIG. 5 is a flow chart of a method of manufacturing a light guide plate provided in a third embodiment of the present disclosure;

FIG. 6 is a schematic view of the structure of a backlight module provided in a fourth embodiment of the present disclosure; and

FIG. 7 is a schematic view of the structure of a display device provided in a fifth embodiment of the present disclosure.

### DETAILED DESCRIPTION

To make the technical solutions and advantages of the embodiments of the present disclosure clearer, the technical solutions of the embodiments of the present disclosure will be described below clearly and comprehensively with reference to the accompanying drawings. It is obvious that the described embodiments are part of the present disclosure, not all the embodiments. All other embodiments obtained by those skilled in the art based on the described embodiments of the present disclosure without the need for creative work are also within the scope of the present disclosure.

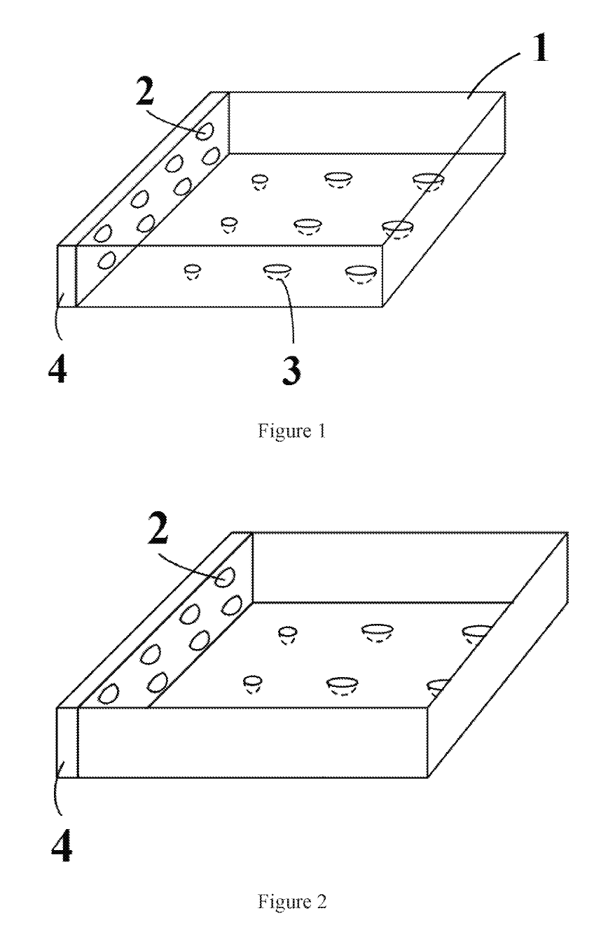

FIG. 1 is a schematic view of the structure of a light guide plate 1 provided in a first embodiment of the present disclosure. As shown in FIG. 1, the light guide plate 1 guides the light emitted by a light source. The light incident surface of the light guide plate 1 attaches to, i.e. closely abuts and fits, the light emergent surface of the light source 2. According to embodiments of the present disclosure, the light incident surface of the light guide plate 1 attaches to the light emergent surface of the light source 2 to reduce or eliminate the gap between the light guide plate 1 and the light source 2, thereby reducing the loss of light, reducing the energy consumption, and improving the display effect.

In embodiments of the present disclosure, the light guide plate 1 may be integrated with the light source 2. The light guide plate 1 may further include a dot distribution surface which intersects with the light incident surface. There are a plurality of dots 3 arranged on the dot distribution surface. On the dot distribution surface, the number of the dots 3 may increase along a direction away from the light incident surface, and a size of the dot 3 may also increase. The light guide plate 1 may include silicon rubber. It is to be understood that this is not intended to limit the material of the light guide plate 1, and any light-transmitting material is suitable as long as it can be molded.

According to embodiments of the present disclosure, the light guide plate 1 may be integrated with the light source 2, so as to further eliminate the gap between the light guide plate 1 and the light source 2. The dots 3 are used for guiding light. The number and size of the dots 3 may be set, such that, nearby the light source 2, the scattering of the light of the light source 2 may be less, and, away from the light source 2, the scattering of the light of the light source 2 may be more, such that the outgoing light of the light guide plate 1 is uniform. In addition, the silicon rubber is easy to be integrated with the light source 2.

According to embodiments of the present disclosure, the light source 2 may be arranged on a circuit board 4, such that the circuit board 4 with the light source 2 may be integrated with the light guide plate 1.

FIG. 2 is a schematic view of a first structure of a light guide plate mold provided in a second embodiment of the present disclosure. As shown in FIG. 2, according to the second embodiment of the present disclosure, there is provided a light guide plate mold for manufacturing the light guide plate 1 described above. The light guide plate mold includes a bottom plate and a side plate. The side plate includes the circuit board 4 with the light source 2.

According to embodiments of the present disclosure, the side plate of the light guide plate mold includes a circuit board 4 with a light source 2, specifically on the side of the light incident surface. Thus, the light incident surface of the light guide plate 1 attaches to the light emergent surface of the light source 2, reducing or eliminating the gap between the light guide plate 1 and the light source 2, reducing loss of light, reducing energy consumption, and improving display effect.

In embodiments of the present disclosure, the circuit board 4 with the light source 2 may be integrated with the light guide plate 1. The bottom plate may include a plurality of recesses configured to form a plurality of dots 3 of the light guide plate 1. On the bottom plate, along the direction away from the side plate (the circuit board 4) on the side of the light incident surface, the number of recesses may increase, and the size of the recess may also increase.

According to embodiments of the present disclosure, the light guide plate 1 may be integrated with the light source 2. The gap between the light guide plate 1 and the light source 2 may be further eliminated. The recesses are configured to form the dots 3. The number and size of the recesses are set to form the dots 3, such that, nearby the light source 2, the scattering of the light of the light source 2 may be less, and, away from the light source 2, the scattering of the light of the light source 2 may be more, such that the outgoing light of the light guide plate 1 is uniform.

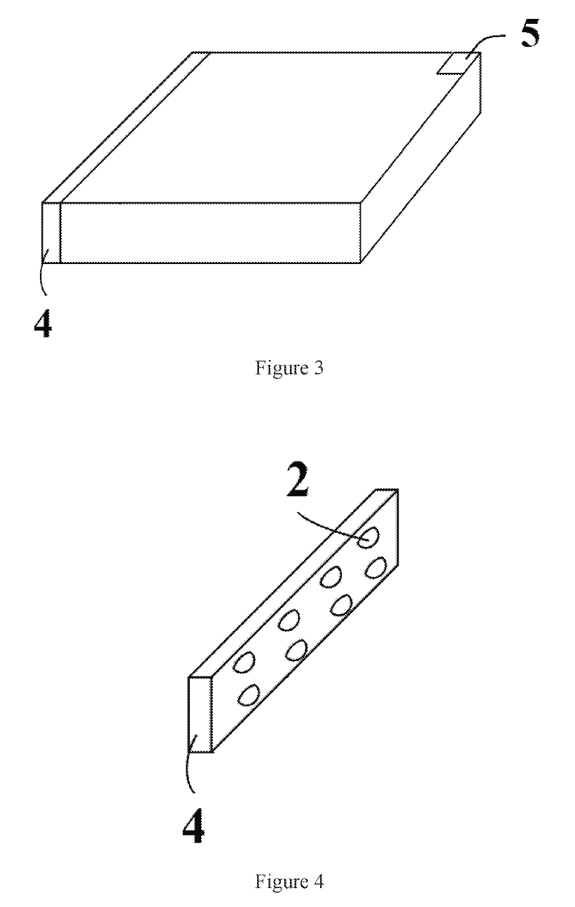

FIG. 3 is a schematic view of a second structure of the light guide plate mold provided in the second embodiment of the present disclosure. As shown in FIG. 3, in embodiments of the present disclosure, the light guide plate mold may further include a cover plate with a hole 5.

According to embodiments of the present disclosure, the cover plate may cause the upper surface of the light guide plate to be flattened, and the hole 5 may be used for the injection of the material for forming the light guide plate 1 into the mold.

FIG. 4 is a schematic view of the structure of a circuit board 4 in the light guide plate mold provided in embodiments of the present disclosure. As shown in FIG. 4, the circuit board 4 includes a light source 2, for example, a plurality of light emitting diode (LED) lamps. The light source 2 may also be a cold cathode fluorescent lamp (CCFL) or other type. After the light guide plate 1 is formed, the circuit board 4 with the light source 2 may be integrated with the light guide plate 1.

According to embodiments of the present disclosure, the light guide plate mold includes a circuit board 4 such that the light incident surface of the light guide plate 1 attaches to the light emergent surface of the light source 2, to reduce or eliminate the gap between the light guide plate 1 and the light source 2, reducing loss of light, reducing energy consumption, and improving display effect.

According to embodiments of the present disclosure, the circuit board 4 with the light source 2 is integrated with the light guide plate 1. The gap between the light guide plate 1 and the light source 2 may be further eliminated.

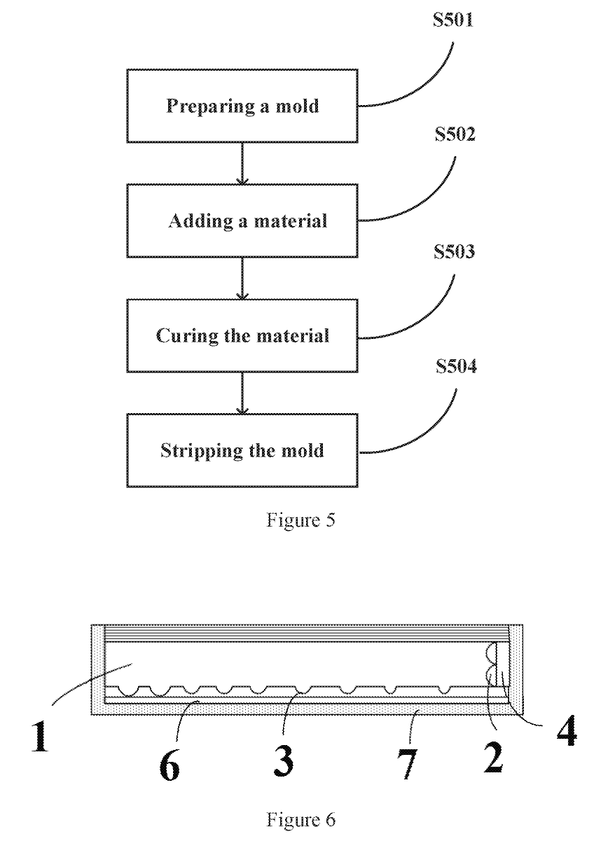

FIG. 5 is a flow chart of a method of manufacturing a light guide plate 1 provided in a third embodiment of the present disclosure. As shown in FIG. 5, the method for manufacturing the light guide plate 1 includes step S501, preparing a light guide plate mold, step S502, adding a material for preparing the light guide plate 1 into the mold, step S503, curing the material, and step S504, stripping the mold to obtain the light guide plate 1. The light guide plate mold includes a bottom plate and a side plate. The side plate includes a circuit board 4 with the light source 2, on the side of the light incident surface.

In embodiments of the present disclosure, preparing a light guide plate mold in step S501 includes providing a light source 2, such as an LED lamp, on the circuit board 4. The light guide plate mold includes a bottom plate and a side plate, and the circuit board 4 with the LED lamp is used as portion of the side plate of the mold for forming the light incident surface of the light guide plate 1. The other portions of the side plate may be strippable. The bottom plate may include recesses for the formation of the dots 3 of the light guide plate 1. The closer to the LED lamp the smaller the recesses, the less the number of the recesses, whereas the further from the LED lamp the larger the recesses, the greater the number of the recesses. The recesses may be arranged in different shapes, which may include a variety of shapes corresponding to existing shapes of the dots 3 of the light guide plate 1. The bottom plate may also not include recesses. In this case, the dots 3 may be printed onto the light guide plate 1 after the light guide plate is molded. Further, after the dots 3 are formed using the recesses, the dots 3 may also be added in a printing manner to adjust the light guiding performance. The light guide plate mold may also include a cover plate with a hole 5.

In embodiments of the present disclosure, adding a material for preparing the light guide plate 1 into the mold in step S502 includes adding a material including the mixed organic silicon pouring sealant and curing agent into the mold. The organic silicon pouring sealant is easy to cure and has good light transmission. However, it should be understood that this is not intended to limit the material for preparing the light guide plate 1. Before being added, the material may be kept standing to remove air. The material may be kept standing for 5 minutes, which facilitates to remove the air added during the mixture. In order to enhance the effect of removing air, the material may be subjected to vacuum defoaming. The weight ratio of the organic silicon pouring sealant to the curing agent may be equal to or more than 100:10, and less than or equal to 100:1. In this way, it is possible to ensure a good light guiding effect while ensure the strength of the curing. Wherein, the weight ratio of the organic silicon pouring sealant and curing agent may be 100:5. To increase the content of the organic silicon pouring sealant as much as possible, may improve the light guiding performance of the light guide plate 1. The organic silicon pouring sealant may be a one-component organic silicon pouring sealant or a two-component organic silicon pouring sealant. The organic silicon pouring sealant may be room-temperature silicon sulfide rubber or high-temperature silicon sulfide rubber. The room-temperature silicon sulfide rubber may be a one-component room-temperature silicon sulfide rubber, a two-component condensed room-temperature silicon sulfide rubber or a two-component addition type room-temperature silicon sulfide rubber. The manner of curing the material for preparing the light guide plate 1 may include room-temperature curing or heat curing.

In embodiments of the present disclosure, the manner of curing the material for preparing the light guide plate 1 in step S503 includes curing at room-temperature (usually 25° C.) or heat curing, which may be selected depending on the material. The curing reaction may begin at the beginning of the mixing process. During the curing process, the material has a gradually increased viscosity and is then converted to a solid elastomer.

In embodiments of the present disclosure, stripping the mold to obtain the light guide plate 1 in step S504 includes stripping the bottom plate constituting the mold and the strippable portions of the side plate after the completion of the curing. The circuit board 4 provided with the light source 2 is retained such that the circuit board 4 may be integrated with the light guide plate 1 without being stripped.

In embodiments of the present disclosure, the method for manufacturing the light guide plate 1 may further include finishing the light guide plate 1, after stripping the mold to obtain the light guide plate 1. The surface of the light guide plate 1 may be selectively finished according to the requirements for the flatness of the light guide plate 1.

FIG. 6 is a schematic view of the structure of a backlight module provided in a fourth embodiment of the present disclosure. As shown in FIG. 6, the backlight module includes a reflective film 6, a bottom frame 7, and the light guide plate 1 described above, the light guide plate 1 being formed integrally with the circuit board 4 including the light source 2.

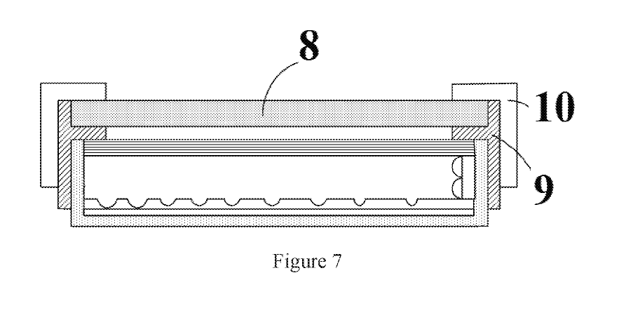

FIG. 7 is a schematic view of the structure of a display device provided in a fifth embodiment of the present disclosure. As shown in FIG. 7, embodiments of the present disclosure also provide a display device including the above-described backlight module, a liquid crystal panel 8, a support frame 9 for supporting the liquid crystal panel 8 and the backlight module, and a frame 10. The display device may be any product or component having a display function such as an electronic paper, an OLED panel, a mobile phone, a tablet computer, a television set, a monitor, a notebook computer, a digital photo frame, a navigator, or the like.

According to the light guide plate and the mold and the manufacturing method thereof, the backlight module and the display device in the embodiments of the present disclosure, the light incident surface of the light guide plate 1 attaches to the light emergent surface of the light source 2, reducing or removing the gap between the light guide plate 1 and the light source 2, reducing loss of light, reducing energy consumption, and improving display quality.

It is to be understood that the above embodiments are merely exemplary embodiments for the purpose of illustrating the principles of the present disclosure, however, the present disclosure is not limited thereto. It will be apparent to those of ordinary skill in the art that various modifications and improvements may be made without departing from the spirit and spirit of the present disclosure, which are also to be regarded as the scope of the present disclosure.

1. A light guide plate configured to guide a light emitted from a light source, wherein a light incident surface of the light guide plate attaches to a light emergent surface of the light source.

2. The light guide plate according to claim 1, wherein the light guide plate is integrated with the light source.

3. The light guide plate according to claim 1, further comprising:
a dot distribution surface;
wherein the dot distribution surface intersects with the light incident surface; and
wherein a plurality of dots are arranged on the dot distribution surface.

4. The light guide plate according to claim 3, wherein on the dot distribution surface, at least one of i) the number of the dots increases along a direction away from the light incident surface and ii) a size of the dots increases along a direction away from the light incident surface.

5. (canceled)

6. The light guide plate according to claim 1, wherein the light guide plate comprises silicon rubber.

7. A light guide plate mold for manufacturing the light guide plate according to claim 1, comprising a bottom plate and a side plate, wherein the side plate comprises a circuit board with the light source.

8. The light guide plate mold according to claim 7, wherein the light guide plate is integrated with the circuit board.

9. The light guide plate mold according to claim 7, wherein the bottom plate comprises a plurality of recesses configured to form a plurality of dots of the light guide plate.

10. The light guide plate mold according to claim 9, wherein on the bottom plate, at least one of i) the number of the recesses increases along a direction away from the circuit board and ii) a size of the recesses increases along a direction away from the circuit board.

11. (canceled)

12. The light guide plate mold according to claim 7, further comprising a cover plate with a hole.

13. A method for manufacturing the light guide plate according to claim 1, comprising:
preparing a light guide plate mold;
adding a material for preparing the light guide plate into the mold;
curing the material; and
stripping the mold to obtain the light guide plate;
wherein the light guide plate mold comprises a bottom plate and a side plate; and
wherein the side plate comprises a circuit board with the light source on the side of the light incident surface.

14. The light guide plate manufacturing method according to claim 13, wherein stripping the mold to obtain the light guide plate comprises retaining the circuit board such that the circuit board and the light guide plate are integrally molded.

15. The light guide plate manufacturing method according to claim 13, wherein the bottom plate of the light guide plate mold comprises a plurality of recesses.

16. The light guide plate manufacturing method according to claim 13, further comprising printing a plurality of dots on the light guide plate after stripping the mold to obtain the light guide plate.

17. The light guide plate manufacturing method according to claim 13, further comprising keeping the material standing to remove the air before adding the material for preparing the light guide plate into the mold.

18. (canceled)

19. The light guide plate manufacturing method according to claim 17, further comprising performing vacuum defoaming on the material.

20. The light guide plate manufacturing method according to claim 13, wherein the material for preparing the light guide plates comprises organic silicon pouring sealant;
wherein the organic silicon pouring sealant comprises at least one of room-temperature silicon sulfide rubber and high-temperature silicon sulfide rubber; and
wherein curing the material comprises at least one of room-temperature curing and heat curing.

21. (canceled)

22. (canceled)

23. The light guide plate manufacturing method according to claim 13, further comprising finishing the light guide plate after stripping the mold to obtain the light guide plate.

24. A backlight module comprising the light guide plate according to claim 1.

25. A display device comprising the backlight module according to claim 24.
